(19) United States
(12) Patent Application Publication
(10) Pub. No.: US 2007/0033585 A1
(43) Pub. Date: Feb. 8, 2007

(54) Electronic appliance

(75) Inventor: Norio Fukui, Osaka (JP)

Correspondence Address: SMITH, GAMBRELL & RUSSELL, 1850 M STREET, N.W., SUITE 800, WASHINGTON, DC, 20036, US

(73) Assignee: KYOCERA MITA CORPORATION

(21) Appl. No.: 11/500,414

(22) Filed: Aug. 8, 2006

(30) Foreign Application Priority Data
Aug. 8, 2005 (JP) 2005-229414

(51) Int. Cl. G06F 9/44

(52) U.S. Cl. 717/168

(57) ABSTRACT

An image forming apparatus is so structured that the version information of firmware stored in an EEPROM of an apparatus main body is compared with the upgrading information on the firmware, the upgrading information containing different pieces of upgrading information for different levels of urgency of upgrading and being stored in a storage area of an EEPROM provided in a toner container, which is a replacement part, in the order of urgency of upgrading, most highest first. Then, the maximum value of the levels of urgency of the individual stages of upgrading required to update the firmware stored in the EEPROM of the apparatus main body up to the latest version is selected, and then message information for giving a notice to prompt upgrading of the firmware, the message information corresponding to the selected level, is displayed on an operation/display portion.

This application is based on Japanese Patent Application No. 2005-229414 filed on Aug. 8, 2005, the contents of which are hereby incorporated by reference.

### BACKGROUND OF THE INVENTION

1. Field of the Invention

The present invention relates to electronic appliances including an image forming apparatus such as a copier, a printer, or a facsimile, and more particularly to a technique of giving a notice to prompt upgrading of firmware.

2. Description of Related Art

In an image forming apparatus such as a printer or a copier, firmware is stored in a non-volatile memory provided in the apparatus main body for controlling the apparatus. As the image forming apparatus has become multifunctional, the firmware installed therein has also become more and more complex. In the image forming apparatus that requires complex control, the firmware stored in the non-volatile memory provided in the apparatus main body is in general structured so that it can be externally rewritten.

Even after the beginning of commercial production and distribution of the image forming apparatus, the firmware installed therein is often upgraded for adding new features, achieving higher performance, or correcting quality problems. With regard to the image forming apparatus whose sales destination or installation location can be kept track of, the firmware thereof is usually upgraded as follows. In accordance with the level of urgency of upgrading, a service person is dispatched to the location for upgrade, or a direct mail or an electronic mail is sent to the user for urging him/her to upgrade the firmware by him/herself. Incidentally, the Internet website of the vendor is used for giving a notice to the user to prompt upgrading of the firmware.

As a conventional technique related to what has been described thus far, JP-A-2002-326375 discloses an ink cartridge recycle system and a method thereof. With this system and method, when a color of the ink in the ink cartridge of a recording apparatus is changed to another color, the compatibility of the firmware installed in the recording apparatus with another ink color is checked by using the version information on the current version of the firmware corresponding to the ink and stored in the non-volatile memory provided in the ink cartridge. At this time, if the ink color can be changed to another color by upgrading the firmware installed in the recording apparatus even when the firmware lacks the compatibility, the user terminal is made to display a message to that effect.

As another conventional technique related to what has been described thus far, JP-A-2004-255847 discloses and proposes the following printing system. In this printing system, when print data of a printer and data for updating of the firmware, the data obtained from the website of the printer manufacturer via the Internet, for example, are transmitted to the printer from a personal computer as one piece of continuous data, the printer compares the version of the firmware on the printer side with the version of the data for updating of the firmware, and then checks the need for upgrading. If upgrading is found to be necessary, the firmware on the printer side is upgraded, and then printing is performed.

It is true that, if the sales destination or installation location of the apparatus main body can be kept track of, the conventional image forming apparatuses permit the service person, the user who has been notified of upgrading by a direct mail or an electronic mail, for example, or the user who has viewed the website of the vendor to use the personal computer connected to the apparatus main body so as to upgrade the firmware currently stored in the non-volatile memory of the apparatus main body up to the latest firmware stored in a storage medium or downloaded from the Internet.

With the ink cartridge recycle system and the method thereof disclosed in JP-A-2002-326375, it is possible to give a notice to the user to prompt upgrading of the firmware when a color of the ink in the ink cartridge is changed to another color because, if the ink color can be changed to another color by upgrading the firmware installed in the recording apparatus even when the firmware lacks the compatibility, a message to that effect is displayed.

With the printing system disclosed in JP-A-2004-255847, it is possible to upgrade the firmware on the printer side by comparing the version of the firmware on the printer side with the version of the data for updating of the firmware, and, when upgrading of the firmware is necessary, extracting the data for updating of the firmware from one piece of continuous data.

However, the conventional image forming apparatuses suffer from the following problems. If the firmware is upgraded after the apparatus main body is distributed, the distributor checks each sales destination or installation location of the apparatus main body for the need for upgrading, then gives a notice to prompt upgrading if necessary, and then makes the service person or the user upgrade the firmware. This disadvantageously increases costs of giving a notice to prompt upgrading of the firmware.

In addition, with regard to the apparatus main body whose installation location cannot be kept track of due to the resale or transfer, for example, of the image forming apparatus, it is impossible for the distributor to give a notice to prompt upgrading of the firmware. As a result, even when upgrading having a high level of urgency has taken place, it is difficult to give a notice to all the sales destinations to prompt upgrading of the firmware.

Furthermore, if the user cannot use the Internet, it is difficult to give a notice to the user to prompt upgrading of the firmware by using the website. Even if the user can use the Internet, he/she does not always view the website of the vendor. This hardly ensures that a notice to prompt upgrading of the firmware is reliably given to the user.

Now, with respect to the ink cartridge recycle system and the method thereof disclosed in JP-A-2002-326375, the following problem arises. In this ink cartridge recycle system and the method thereof, the version information on the current version of the firmware stored in the non-volatile memory provided in the ink cartridge is used as a criterion whether or not the ink in the ink cartridge can be used in the recording apparatus. As a result, even if upgrading of the firmware having a high level of urgency took place on the vendor side and that firmware upgrading would permit the use of a changed ink color, a notice to prompt upgrading is not given.

On the other hand, with the printing system disclosed in JP-A-2004-255847, the following problem arises. If the firmware is upgraded after the apparatus main body is distributed, the distributor checks each sales destination or installation location of the apparatus main body for the need for upgrading, and then gives a notice to prompt upgrading of the firmware if necessary. This disadvantageously increases costs of giving a notice to prompt upgrading of the firmware.

Furthermore, with the conventional techniques described above, it is impossible to change a notification method for different levels of urgency of upgrading of the firmware. A notice to prompt upgrading is given in exactly the same way regardless whether it relates to a major firmware change for installing a new feature or correcting a major problem that would jeopardize the safety of the product, or relates to a minor firmware change. This makes it difficult to communicate the urgency of upgrading of the firmware to the user.

### SUMMARY OF THE INVENTION

In view of the conventionally experienced problems described above, an object of the present invention is to provide an electronic appliance that can give a notice to prompt upgrading of firmware according to the level of urgency of upgrading.

To achieve the above object, according to the present invention, an electronic appliance is provided with: a removable replacement part including a non-volatile memory for storing upgrading information on firmware of the electronic appliance, the upgrading information containing different pieces of upgrading information for different levels of urgency of upgrading; rewritable storage means for storing message information for giving a notice to prompt upgrading of the firmware, the message information containing different pieces of message information for the different levels of urgency of upgrading, and version information on the current version of the firmware; notification means for providing notification of the message information; comparison/selection means for comparing the version information stored in the storage means with the upgrading information stored in the non-volatile memory, the upgrading information containing the different pieces of upgrading information for the different levels of urgency of upgrading, and selecting a predetermined level of urgency; and control means for making the notification means provide notification of the message information for giving a notice to prompt upgrading, the message information corresponding to the predetermined level of urgency selected by the comparison/selection means.

With this structure, it is possible to give a notice to the user to prompt upgrading of the firmware according to the level of urgency of upgrading by supplying a replacement part. This makes it possible to urge the user to take appropriate action.

In the electronic appliance structured as described above, the different pieces of upgrading information for the different levels of urgency of upgrading are each version information on firmware most recently upgraded with a corresponding level of urgency of upgrading.

With this structure, it is possible to give a notice to the user to prompt upgrading of the firmware as most recently prepared according to the level of urgency of upgrading by supplying a replacement part.

In the electronic appliance structured as described above, the notification means is printing means for printing a predetermined image on paper, and, when the predetermined level of urgency is selected by the comparison/selection means, the control means makes the printing means automatically print on the paper the message information for giving a notice to prompt upgrading, the message information corresponding to the predetermined level of urgency.

With this structure, it is possible to give a notice to the user to prompt upgrading of the firmware according to the level of urgency of upgrading by supplying a replacement part. Furthermore, if the printed page contains a firmware upgrading procedure, the user can grasp the firmware upgrading procedure quickly and easily.

In the electronic appliance structured as described above, when the control means finds the predetermined level of urgency to be equal to or greater than a first preset level, the control means makes the notification means provide the message information for giving a notice to prompt upgrading, the message information corresponding to the predetermined level of urgency, and then stops a main body of the appliance.

With this structure, it is possible to urge the user to contact a vendor, and ensure the correction of the major problem that would jeopardize the product safety of the electronic appliance.

The electronic appliance structured as described above is further provided with: operation means for inputting information; and setting means for disabling, when predetermined setting information is received by the operation means and the control means finds the predetermined level of urgency to be equal to or smaller than a second preset level, notification of the message information for giving a notice to prompt upgrading, the message information corresponding to the predetermined level of urgency.

With this structure, it is possible to give only a notice to prompt upgrading of the firmware having a high level of urgency to the user who finds it unnecessary to receive a notice to prompt upgrading of the firmware having a low level of urgency.

As described above, according to the electronic appliance of the present invention, it is possible to give a notice to the user to prompt upgrading of the firmware according to the level of urgency of upgrading by supplying a replacement part.

### BRIEF DESCRIPTION OF THE DRAWINGS

FIG. 1 is a block diagram showing the structure of a principal portion of the image forming apparatus embodying the present invention;

FIG. 2 is a longitudinal sectional view schematically showing the structure of a principal portion of the image forming apparatus embodying the present invention;

FIG. 3 is a table for explaining an example of upgrading information on firmware, the upgrading information containing different pieces of upgrading information for different levels of urgency of upgrading and being stored in the EEPROM 141 provided in the newly installed toner container 14;

FIG. 4 is a table showing the definitions of different levels of urgency of upgrading of the firmware;

FIG. 5 is a flow chart showing, as one example, the operation performed by the image forming apparatus 1 to give a notice to prompt upgrading of the firmware according to the level of urgency; and

FIG. 6 is a diagram for explaining an example of a notice to prompt upgrading of the firmware according to the level of urgency based on the version information of the firmware stored in the EEPROM 161 of the image forming apparatus 1.

### DETAILED DESCRIPTION OF PREFERRED EMBODIMENTS

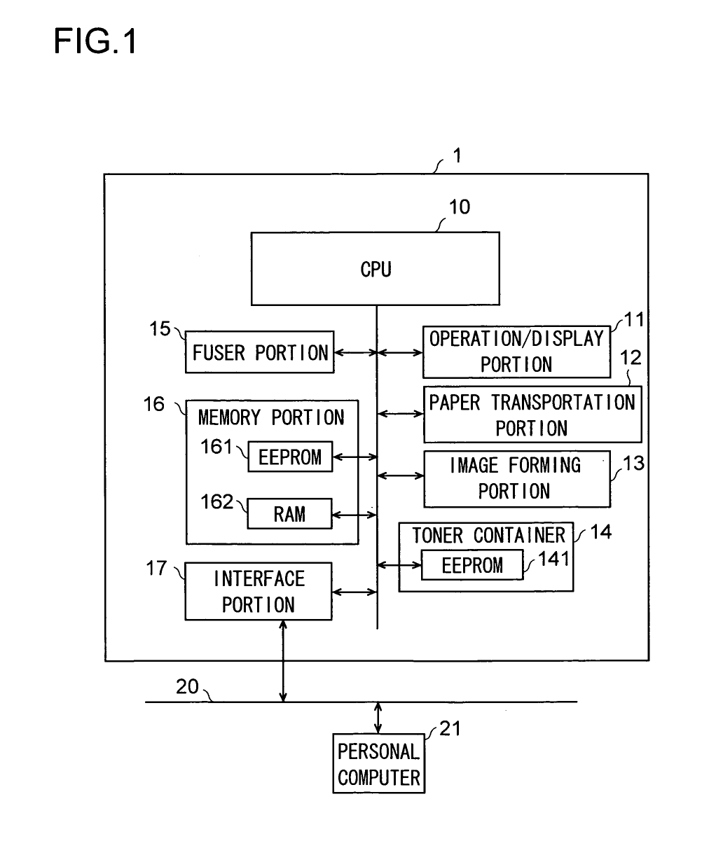

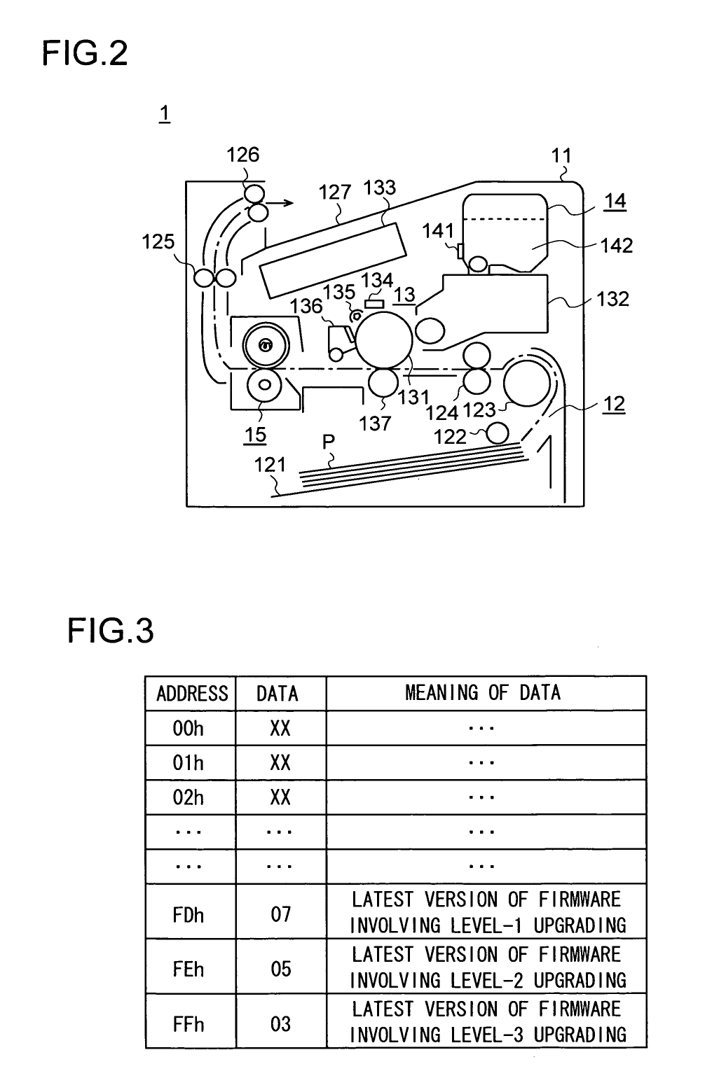

A description will be given below, taking up as a case in which the present invention is applied to an image forming apparatus. FIG. 1 is a block diagram showing the structure of a principal portion of the image forming apparatus embodying the present invention. FIG. 2 is a longitudinal sectional view schematically showing the structure of a principal portion of the image forming apparatus embodying the present invention. As shown in FIGS. 1 and 2, the image forming apparatus 1 of this embodiment is built with a central processing unit 10 (hereinafter referred to as a CPU 10), an operation/display portion 11, a paper transporting portion 12, an image forming portion 13, a toner container 14, a fuser portion 15, a memory portion 16, and an interface portion 17. The CPU 10 controls operation of the entire apparatus. The operation/display portion 11 consists of operation means (such as a numeric keypad or a touch panel) and display means (such as a liquid crystal display). The paper transporting portion 12 transports paper P. The image forming portion 13 forms a toner image on the paper P based on the image data. The toner container 14 is a removable replacement part that contains toner 142 to be fed to a developer 132, which will be described later, of the image forming portion 13. The fuser portion 15 fixes the toner image obtained by the image forming portion 13 to the paper P. The memory portion 16 stores various programs, firmware, data, and so on, and also serves as a work area. The interface portion 17 connects between an external network 20 and this image forming apparatus for communication therebetween.

In addition to controlling the operation of the entire apparatus, the CPU 10 carries out processing for giving a notice to prompt upgrading of the firmware, which will be specifically described later. Furthermore, the CPU 10 serves as comparison/selection means for comparing version information on the current version of the firmware stored in an EEPROM 161, which will be described later, with upgrading information on the firmware, the upgrading information containing different pieces of upgrading information for different levels of urgency and being stored in an EEPROM 141, which will be described later, and selecting a predetermined level of urgency.

The paper transporting portion 12 is built with a paper accommodating portion 121, a paper feed roller 122, a transportation roller 123, resist rollers 124, a pair of transportation rollers 125, a pair of ejection rollers 126, and a catch tray 127. The paper accommodating portion 121 feeds paper to the image forming portion 13. The paper feed roller 122 sends the sheets of paper P one at a time from the paper accommodating portion 121. The transporting roller 123 transports the paper P sent from the paper feed roller 122 to the resist roller 124, which will be described below. The resist rollers 124 correct the orientation of the paper P transported from the transportation roller 123, and then transports the paper P to the image forming portion 13 in conjunction with the operation of the image forming portion 13. The transportation rollers 125 transport the paper P ejected from the fuser portion 15 to the ejection rollers 126, which will be described below. The ejection rollers 126 eject the paper P transported from the transportation rollers 125 onto the catch tray 127. The catch tray 127 catches the paper P ejected from the ejection rollers 126.

The image forming portion 13 is built with a photoconductive drum 131, a charger 134, an exposure unit 133, a developer 132, a transfer roller 137, a cleaning portion 136, and a discharger 135. The photoconductive drum 131 is a latent image carrying member, and a toner image is formed on the surface thereof based on the image data. The charger 134 charges the surface of the photoconductive drum 131 to a predetermined uniform potential. The exposure unit 133 irradiates the surface of the photoconductive drum 131 with laser light based on the image data, thereby forming an electrostatic latent image on the surface of the photoconductive drum 131. The developer 132 develops the electrostatic latent image formed on the surface of the photoconductive drum 131 so as to form a toner image on the surface of the photoconductive drum 131. The transfer roller 137 electrostatically transfers the toner image formed on the surface of the photoconductive drum 131 to the transported paper P. The cleaning portion 136 removes the toner remaining on the surface of the photoconductive drum 131. The discharger 135 removes the electrical charges remaining on the surface of the photoconductive drum 131.

The memory portion 16 is built with an EEPROM (electronically erasable and programmable read-only memory) 161 and a RAM (random-access memory) 162. The EEPROM 161 is an electrically rewritable non-volatile memory in which not only various programs and data, for example, but also firmware for controlling the apparatus main body and a version thereof are stored, and, when the firmware is upgraded, the updated firmware and the version thereof are stored. The RAM 162 serves as a work area.

The EEPROM 161 of the memory portion 16 also stores message information for giving a notice to prompt upgrading of the firmware, the message information containing different pieces of message information for different levels of urgency of upgrading.

The toner container 14, besides having the toner 142, also has the EEPROM 141 that is an electrically rewritable non-volatile memory. The toner container 14 is usually designed to contain enough toner to print 5000 to 20000 pages, and is a consumable supply that is regularly replaced with the new one to permit the continuing use of the image forming apparatus 1. Moreover, instead of using the EEPROM 141, it is also possible to use, for example, a flash memory that is an electrically rewritable non-volatile memory, or a read-only OTPROM (One Time Programmable ROM). Furthermore, instead of using the EEPROM 141, it is also possible to use RFID (Radio Frequency Identification) by attaching, to the toner container 14, a wireless IC tag provided with an electrically rewritable non-volatile memory.

As shown in FIG. 2, the toner container 14 is installed in such a way that it can replenish the developer 132 with the toner 142. When the toner 142 is consumed, the toner container 14 is detached by the user, and then a new toner container filled with the toner 142 is installed in the location shown in FIG. 2.

When the toner container 14 is installed, the EEPROM 141 is electrically connected to the CPU 10, and writing data to and reading data from the EEPROM 141 is controlled by the CPU 10.

In addition to manufacturing information such as type, amount, serial number, and factory location code of the toner 142 in the toner container 14, the EEPROM 141 also prestores upgrading information on the firmware in a predetermined storage area, the upgrading information containing different pieces of upgrading information for different levels of urgency of upgrading, which will be specifically described below. Furthermore, the amount of toner consumed or the number of sheets printed in image forming processing is updated by the CPU 10 with each image forming operation (that is, printing operation), and is then stored in the EEPROM 141 so that the CPU 10 can estimate the amount of toner remaining in the toner container 14.

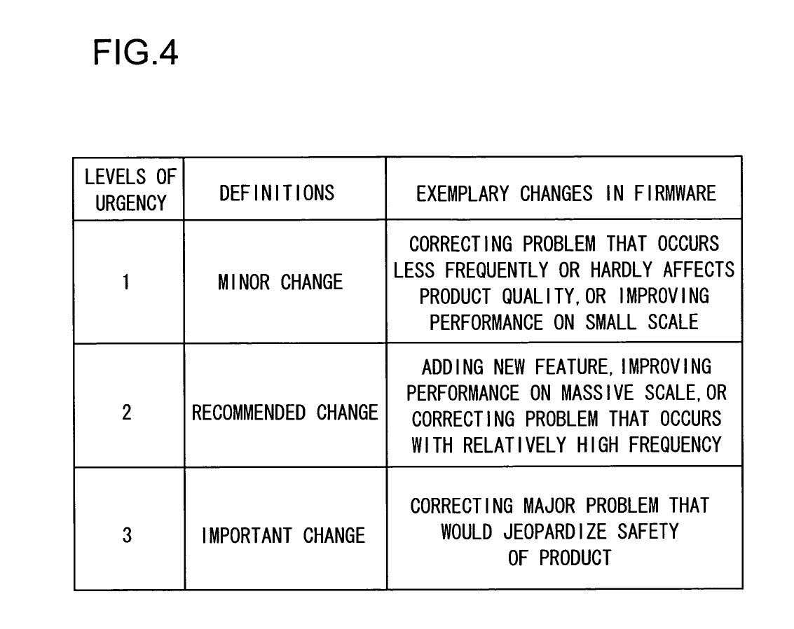

Here, FIG. 3 is a table for explaining an example of upgrading information on firmware, the upgrading information containing different pieces of upgrading information for different levels of urgency of upgrading and being stored in the EEPROM 141 provided in the newly installed toner container 14. FIG. 4 is a table showing the definitions of different levels of urgency of upgrading of the firmware. It is to be noted that the table shown in FIG. 3 shows an address, data stored in a storage area corresponding to the address, and the meaning of the data, while showing only addresses FDh to FFh, data stored in the storage areas corresponding to these addresses, and the meaning of the data. Incidentally, version information of a firmware product is set as follows. At the start of commercial production of the image forming apparatus 1, the first released version of a firmware product has version “01”. In subsequent upgrading, the version number is sequentially incremented by 1. The greater the version number of the firmware, the newer the version thereof.

As shown in FIG. 3, the EEPROM 141 has a 256-byte storage area with addresses from 00h to FFh. In the storage areas of the EEPROM 141 corresponding to the addresses FDh to FFh, different pieces of latest upgrading information on the firmware for different levels of urgency, from 1 to 3, are stored as follows. For example, in the storage area of the EEPROM 141 corresponding to the address FDh, the number of latest firmware involving level-1 upgrading, “07”, is stored; in the storage area corresponding to the address FEh, the number of latest firmware involving level-2 upgrading, “05”, is stored; and in the storage area corresponding to the address FFh, the number of latest firmware involving level-3 upgrading, “03”, is stored.

Now, a description will be given of the definitions of different levels of urgency of upgrading of the firmware and exemplary changes in the firmware at three different levels of urgency. As shown in FIG. 4, level 1 is defined as a minor change in the firmware. For example, level-1 upgrading includes correcting a problem that occurs less frequently or hardly affects the product quality and improving performance on a small scale. Level 2 is defined as a recommended change in the firmware. For example, level-2 upgrading includes adding a new feature, improving performance on a massive scale, and correcting a problem that occurs with relatively high frequency. Level 3 is defined as an important change in the firmware. For example, level-3 upgrading includes correcting a major problem that would jeopardize the safety of the product.

Now, as shown in FIG. 1, the image forming apparatus 1 of this embodiment is connected to the network 20 via the interface portion 17, whereby it can transmit and receive data and print data, for example, to and from a personal computer 21 connected to the network 20. It is to be noted that, in this embodiment, one personal computer 21 is connected to the network 20; however, a plurality of personal computers 21 may be connected thereto.

Though not shown in the drawing, the personal computer 21 connected to the network 20 includes a storage portion that stores various programs and data, for example, and that also serves as a work area, a display on which an image is displayed, an input device used by the user for input operation, a control portion that performs overall control of the personal computer 21, and an interface that establishes communication with an external apparatus. The personal computer 21 can transmit and receive data and print data, for example, to and from the external apparatus such as the image forming apparatus 1.

Next, image forming operation (printing operation) of the image forming apparatus 1 structured as described above will be described. In FIG. 2, dashed-arrowed line represents a transportation path of paper P. The image forming operation of the image forming apparatus 1 of this embodiment is performed as follows. When print data transmitted from the personal computer 21 is received by the interface portion 17, the print data thus received is temporarily stored in the memory portion 16 by the CPU 10. The print data is then read therefrom, and image data is extracted from the print data, and is then transmitted to the image forming portion 13. Subsequently, image forming processing is started in the image forming portion 13 so that, based on the image data, an electrostatic latent image is formed by the exposure unit 133 on the surface of the photoconductive drum 131, the surface being uniformly charged by the charger 134 to a predetermined potential. Then, the electrostatic latent image thus formed is developed by the developer 132, so that a toner image is formed on the surface of the photoconductive drum 131. The toner image formed on the surface of the photoconductive drum 131 is transferred, by the transfer roller 137, to the paper P transported by the paper feed roller 122, the transportation roller 123, and the resist rollers 124.

Then, the paper P carrying loose toner image is sent to the fuser portion 15, where the toner image is fixed to the paper P by the application of heat and pressure. The paper P is then ejected into the catch tray 127 by the transportation rollers 125 and ejection rollers 126. Meanwhile, the toner remaining on the surface of the photoconductive drum 131 is removed by the cleaning portion 136, and the surface of the photoconductive drum 131 is discharged by the discharger 135.

The distinctive feature of the image forming apparatus 1 of this embodiment is that the necessity and level of urgency of upgrading of the firmware is checked by comparing upgrading information on the firmware, the upgrading information containing different pieces of upgrading information for different levels of urgency of upgrading and being stored in the storage area of the EEPROM 141 provided in the toner container 14, which is a replacement part, with version information on the current version of the firmware stored in the EEPROM 161 of the apparatus main body, and a notice to prompt upgrading of the firmware is given according to the level of urgency of upgrading.

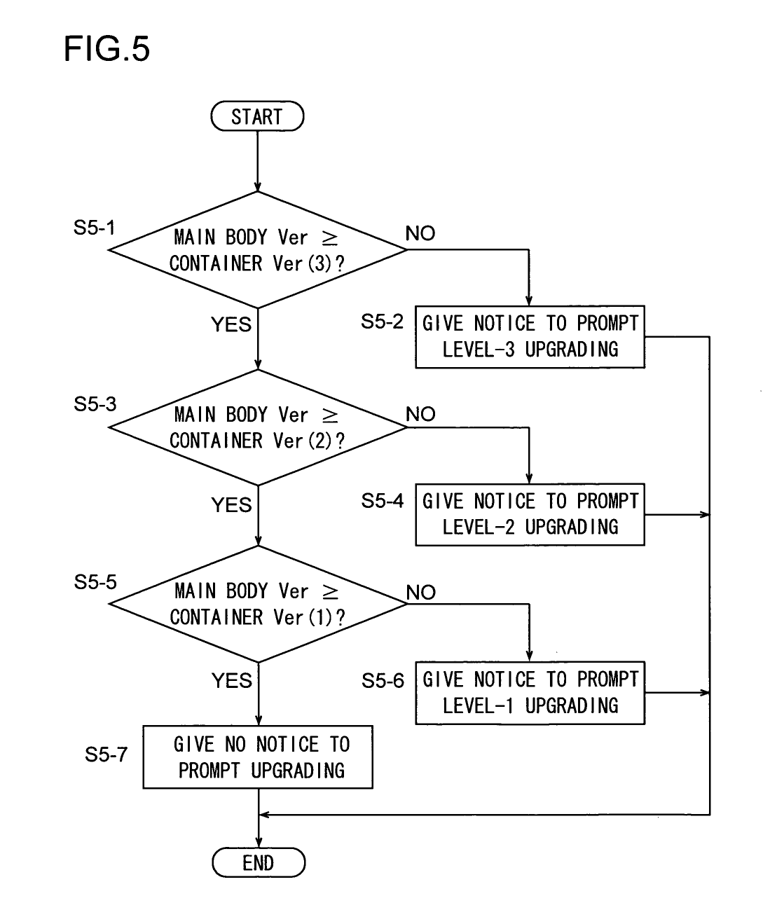

The above-described feature of the image forming apparatus 1 of this embodiment will be described in detail with reference to the drawings. FIG. 5 is a flow chart showing, as one example, the operation performed by the image forming apparatus 1 to give a notice to prompt upgrading of the firmware according to the level of urgency. In FIG. 5, main body Ver represents the version information on the current version of the firmware stored in the EEPROM 161 provided in the apparatus main body of the image forming apparatus 1, and container Ver (X) represents the latest upgrading information on the firmware involving level-X upgrading, the upgrading information stored in the EEPROM 141 of the toner container 14.

In the image forming apparatus 1 of this embodiment, when the toner 142 is consumed, the toner container 14 is detached and replaced by a new toner container 14 (hereinafter simply referred to as a toner container 14) filled with the toner 142. When the toner container 14 is installed, the EEPROM 141 provided therein is electrically connected to the CPU 10. Then, data including upgrading information on the firmware, the upgrading information containing different pieces of upgrading information for different levels of urgency of upgrading and being stored in the EEPROM 141 of the toner container 14, is read by the CPU 10. Then, in step S5-1, the CPU 10 compares the version information of the firmware, the version information stored in the EEPROM 161 of the apparatus main body, with the latest upgrading information on the firmware involving level-3 upgrading, the upgrading information stored in the storage area corresponding to the address FFh of the EEPROM 141 provided in the toner container 14.

If the CPU 10 finds the version information of the firmware stored in the EEPROM 161 of the apparatus main body not to be equal to or greater than the latest upgrading information on the firmware involving level-3 upgrading, the upgrading information stored in the storage area corresponding to the address FFh of the EEPROM 141 provided in the toner container 14 (“No” in S5-1), the CPU 10 selects level 3 in step S5-2, whereby message information for giving a notice to prompt level-3 upgrading, the message information stored in the EEPROM 161, is displayed on the operation/display portion 11. For example, as shown in FIG. 4, since level 3 is defined as an important change in the firmware, the CPU 10 makes the operation/display portion 11 display a message saying “BE SURE TO UPGRADE FIRMWARE”.

On the other hand, if the CPU 10 finds the version information of the firmware stored in the EEPROM 161 of the apparatus main body to be equal to or greater than the latest upgrading information on the firmware involving level-3 upgrading, the upgrading information stored in the storage area corresponding to the address FFh of the EEPROM 141 provided in the toner container 14 (“Yes” in S5-1), the procedure proceeds to step S5-3.

Then, in step S5-3, the CPU 10 compares the version information of the firmware stored in the EEPROM 161 of the apparatus main body with the latest upgrading information on the firmware involving level-2 upgrading, the upgrading information stored in the storage area corresponding to the address FEh of the EEPROM 141 provided in the toner container 14.

If the CPU 10 finds the version information of the firmware stored in the EEPROM 161 of the apparatus main body not to be equal to or greater than the latest upgrading information on the firmware involving level-2 upgrading, the upgrading information stored in the storage area corresponding to the address FEh of the EEPROM 141 provided in the toner container 14 (“No” in S5-3), the CPU 10 selects level 2 in step S5-4, whereby message information for giving a notice to prompt level-2 upgrading, the message information stored in the EEPROM 161, is displayed on the operation/display portion 11. For example, as shown in FIG. 4, since level 2 is defined as a recommended change in the firmware, the CPU 10 makes the operation/display portion 11 display a message saying “UPGRADING OF FIRMWARE IS RECOMMENDED”.

On the other hand, if the CPU 10 finds the version information of the firmware stored in the EEPROM 161 of the apparatus main body to be equal to or greater than the latest upgrading information on the firmware involving level-2 upgrading, the upgrading information stored in the storage area corresponding to the address FEh of the EEPROM 141 provided in the toner container 14 (“Yes” in S5-3), the procedure proceeds to step S5-5.

Then, in step S5-5, the CPU 10 compares the version information of the firmware stored in the EEPROM 161 of the apparatus main body with the latest upgrading information on the firmware involving level-1 upgrading, the upgrading information stored in the storage area corresponding to the address FDh of the EEPROM 141 provided in the toner container 14.

If the CPU 10 finds the version information of the firmware stored in the EEPROM 161 of the apparatus main body not to be equal to or greater than the latest upgrading information on the firmware involving level-1 upgrading, the upgrading information stored in the storage area corresponding to the address FDh of the EEPROM 141 provided in the toner container 14 (“No” in S5-5), the CPU 10 selects level 1 in step S5-6, whereby message information for giving a notice to prompt level-1 upgrading, the message information stored in the EEPROM 161, is displayed on the operation/display portion 11. For example, as shown in FIG. 4, since level 1 is defined as a minor change in the firmware, the CPU 10 makes the operation/display portion 11 display a message saying “NEW FIRMWARE EXISTS” or “FIRMWARE IS UPDATED”. This is the end of the operation.

On the other hand, if the CPU 10 finds the version information of the firmware stored in the EEPROM 161 of the apparatus main body to be equal to or greater than the latest upgrading information on the firmware involving level-1 upgrading, the upgrading information stored in the storage area corresponding to the address FDh of the EEPROM 141 provided in the toner container 14 (“Yes” in S5-5), a notice to prompt upgrading of the firmware is not given in step S5-7. This is the end of the operation.

When the firmware stored in the EEPROM 161 of the image forming apparatus 1 is actually upgraded, the latest firmware file is downloaded from an unillustrated vendor's website on the Internet by using the personal computer 21, for example. Thus, irrespective of the level of urgency of the message thus displayed, the firmware is always upgraded to its latest version.

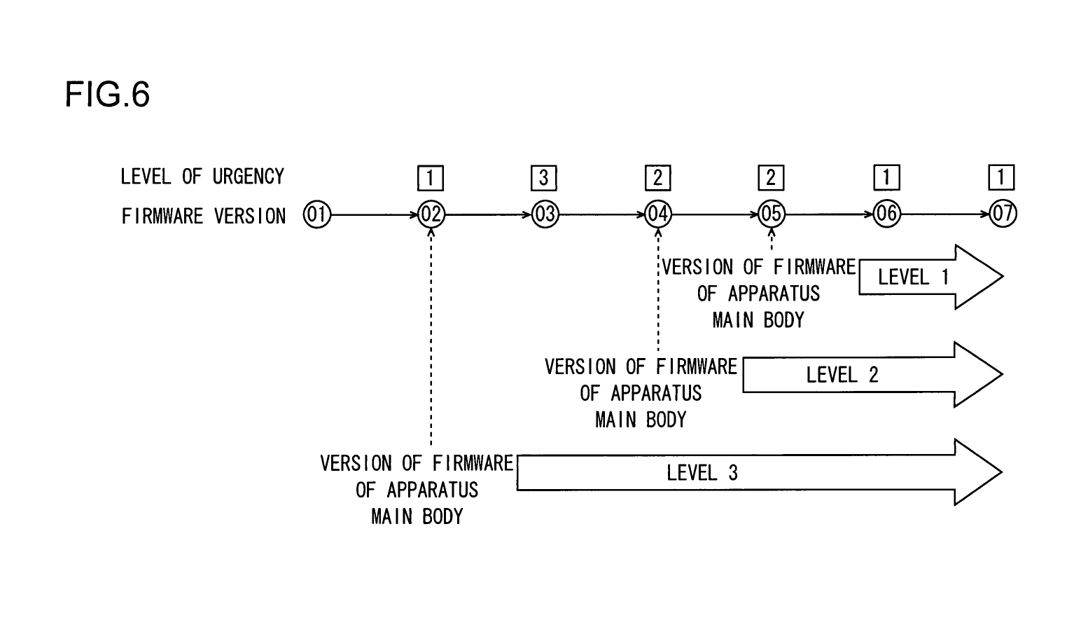

Now, the essentials of a comparison between the version information of the firmware stored in the EEPROM 161 of the apparatus main body and the latest upgrading information on the firmware, the upgrading information containing different pieces of upgrading information for different levels of urgency of upgrading and being stored in the EEPROM 141 of the toner container 14, will be described with reference to FIGS. 3 and 6. The following descriptions assume that the number of latest firmware is “07”. FIG. 6 is a diagram for explaining an example of a notice to prompt upgrading of the firmware according to the level of urgency based on the version information of the firmware stored in the EEPROM 161 of the image forming apparatus 1. In FIG. 6, an encircled number represents version information on the current version of the firmware, and a number enclosed in a rectangle arranged above each encircled number represents the level of urgency of upgrading of the firmware.

As shown in FIG. 6, the number of latest firmware is “07”, and the numbers of latest firmware involving level-1, level-2, and level-3 upgrading are “07”, “05”, and “03” respectively. Based on these facts, as shown in FIG. 3, in the storage area corresponding to the address FDh of the EEPROM 141 of the toner container 14, the number of latest firmware involving level-1 upgrading, “07”, is stored; in the storage area corresponding to the address FEh, the number of latest firmware involving level-2 upgrading, “05”, is stored; and in the storage area corresponding to the address FFh, the number of latest firmware involving level-3 upgrading, “03”, is stored. The above-described version information stored in the storage areas corresponding to the addresses FDh to FFh corresponds to upgrading information.

For example, as shown in FIG. 6, if the version information of the firmware stored in the EEPROM 161 of the apparatus main body is “02”, the version information is compared with the latest upgrading information on the firmware involving level-3, level-2, and level-1 upgrading in this order as described above. In this case, since the number of latest firmware involving level-3 upgrading, “03”, is stored in the storage area corresponding to the address FFh of the EEPROM 141 of the toner container 14, a notice to prompt level-3 upgrading of the firmware is given.

For example, as shown in FIG. 6, if the version information of the firmware stored in the EEPROM 161 of the apparatus main body is “04”, the version information is compared with the latest upgrading information on the firmware involving level-3, level-2, and level-1 upgrading in this order as described above. In this case, since the number of latest firmware involving level-2 upgrading, “05”, is stored in the storage area corresponding to the address FEh of the EEPROM 141 of the toner container 14, a notice to prompt level-2 upgrading of the firmware is given.

For example, as shown in FIG. 6, if the version information of the firmware stored in the EEPROM 161 of the apparatus main body is “05”, the version information is compared with the latest upgrading information on the firmware involving level-3, level-2, and level-1 upgrading in this order as described above. In this case, since the number of latest firmware involving level-1 upgrading, “07”, is stored in the storage area corresponding to the address FDh of the EEPROM 141 of the toner container 14, a notice to prompt level-1 upgrading of the firmware is given.

As described above, according to the image forming apparatus 1 of this embodiment, the version information on the current version of the firmware stored in the EEPROM 161 of the apparatus main body is compared with the upgrading information on the firmware, the upgrading information containing different pieces of upgrading information for different levels of urgency of upgrading and being stored in the storage area of the EEPROM 141 provided in the toner container 14, which is a replacement part, in the order of urgency of upgrading, most highest first. Then, the maximum value of the levels of urgency of the individual stages of upgrading required to update the firmware stored in the EEPROM 161 of the apparatus main body up to the latest version is selected, and then message information for giving a notice to prompt upgrading of the firmware, the message information corresponding to the selected level, is displayed on the operation/display portion 11. This makes it possible to give a notice to the user to prompt upgrading of the firmware as most recently prepared according to the level of urgency of upgrading by supplying a replacement part. Furthermore, since a notice to prompt upgrading of the firmware is given to the user according to the level of urgency, it is possible to urge the user to take appropriate action.

As upgrading information on firmware, the upgrading information containing different pieces of upgrading information for different levels of urgency of upgrading, it is preferable that the vendors that produce the image forming apparatus 1 use unique upgrading information. This makes it possible for the vendors to differentiate their products from those of makers that specialize in production of replacement parts.

In the image forming apparatus 1 of this embodiment, different pieces of message information for giving a notice to prompt level-1, level-2, and level-3 upgrading of the firmware are displayed on the operation/display portion 11 in steps S5-2, S5-4, and S5-6 respectively. Instead, a notice to prompt level-1, level-2, and level-3 upgrading of the firmware may be given in such a way that different written notices to prompt upgrading of the firmware with different messages for different levels of urgency may be automatically printed on sheets of paper in steps S5-2, S5-4, and S5-6. For example, for level-1 upgrading, a message saying that updated firmware exists is printed; for level-2 upgrading, a message saying that upgrading of the firmware is recommended is printed; for level-3 upgrading, a message saying that upgrading of the firmware is compulsory is printed. This makes it possible to give a notice to the user to prompt upgrading of the firmware according to the level of urgency of upgrading by supplying a replacement part. Furthermore, a written notice to prompt upgrading of the firmware may further contain a firmware upgrading procedure. This permits the user to grasp the firmware upgrading procedure quickly and easily and to decide whether or not to upgrade the firmware.

Alternatively, when firmware upgrading having a high level of urgency (for example, level-3 upgrading) is selected by the CPU 10, an emergency contact form may be automatically printed so that the user can fill in user information on the form and then fax it to the service center as it is. This makes it possible for the user to contact the service center as soon as he/she receives a notice to prompt firmware upgrading having a high level of urgency.

The embodiment described above deals with an example in which a level of urgency is assigned to upgrading on a scale of 1 to 3. However, the present invention is not limited to this specific configuration, but may be so implemented that a level of urgency is assigned to upgrading on a predetermined scale.

The following features may be added to the present invention. If the CPU 10 finds a predetermined selected level to be equal to or greater than a first preset level, the operation of the image forming apparatus 1 is stopped by an error until the firmware is upgraded in response to a notice to prompt upgrading of the firmware. This makes it possible to urge the user to contact the vendor, and ensure the correction of the major problem that would jeopardize the product safety of the image forming apparatus 1.

Alternatively, if the CPU 10 finds a predetermined selected level to be equal to or smaller than a second preset level, the user may find it unnecessary to receive a notice to prompt upgrading at that level, and therefore the user is allowed to enable/disable the reception of a notice to prompt upgrading of the firmware according to the level of urgency by operating the operation/display portion 11. This makes it possible to give only a notice to prompt upgrading of the firmware having a high level of urgency to the user who finds it unnecessary to receive a notice to prompt upgrading of the firmware having a low level of urgency.

The embodiment described above deals with an image forming apparatus 1; however, the present invention is not limited to this specific configuration. The present invention finds wide application in electronic appliances having a replacement part, i.e., in any other types of electronic appliances such as facsimiles, copiers, personal computers, or air washers.

Obviously, many modifications and variations of the present invention are possible in light of the above teachings. It is therefore to be understood that within the scope of the appended claims, the invention may be practiced other than as specifically described.

What is claimed is:

1. An electronic appliance comprising:
a removable replacement part including a non-volatile memory for storing upgrading information on firmware of the electronic appliance, the upgrading information containing different pieces of upgrading information for different levels of urgency of upgrading;
rewritable storage means for storing
message information for giving a notice to prompt upgrading of the firmware, the message information containing different pieces of message information for the different levels of urgency of upgrading, and
version information on a current version of the firmware, notification means for providing notification of the message information;
comparison/selection means for comparing the version information stored in the storage means with the upgrading information stored in the non-volatile memory, the upgrading information containing the different pieces of upgrading information for the different levels of urgency of upgrading, and selecting a predetermined level of urgency; and
control means for making the notification means provide notification of the message information for giving a notice to prompt upgrading, the message information corresponding to the predetermined level of urgency selected by the comparison/selection means.

2. The electronic appliance of claim 1,
wherein the different pieces of upgrading information for the different levels of urgency of upgrading are each version information on firmware most recently upgraded with a corresponding level of urgency of upgrading.

3. The electronic appliance of claim 1,
wherein the notification means comprises printing means for printing a predetermined image on paper, and
wherein, when the predetermined level of urgency is selected by the comparison/selection means, the control means makes the printing means automatically print on the paper the message information for giving a notice to prompt upgrading, the message information corresponding to the predetermined level of urgency.

4. The electronic appliance of claim 1,
wherein, when the control means finds the predetermined level of urgency to be equal to or greater than a first preset level, the control means makes the notification means provide the message information for giving a notice to prompt upgrading, the message information corresponding to the predetermined level of urgency, and then stops a main body of the appliance.

5. The electronic appliance of claim 1 further comprising:
operation means for inputting information; and
setting means for disabling, when predetermined setting information is received by the operation means and the control means finds the predetermined level of urgency to be equal to or smaller than a second preset level, notification of the message information for giving a notice to prompt upgrading, the message information corresponding to the predetermined level of urgency.
